(19) United States
(12) Patent Application Publication
(10) Pub. No.: US 2002/0089559 A1
(43) Pub. Date: Jul. 11, 2002

(54) Ink jet printing with noise drop size modulation for reduced image defects

(75) Inventor: Donald J. Drake, Rochester, NY (US)

Correspondence Address: John E. Beck, Xerox Corporation, Xerox Square 20A, Rochester, NY, 14644, US

(73) Assignee: Xerox Corporation

(21) Appl. No.: 09/755,271

(22) Filed: Jan. 8, 2001

(51) Int. Cl. B41J 2/045

(52) U.S. Cl. 347/15

(57) ABSTRACT

An ink jet printing system in which a noise or other random signal generator input randomly slightly varies the size of the ink jet drops relative their normal size to reduce the perception of systematic visible defects in the printed images, such as lines caused by a defective transducer element in the printhead.

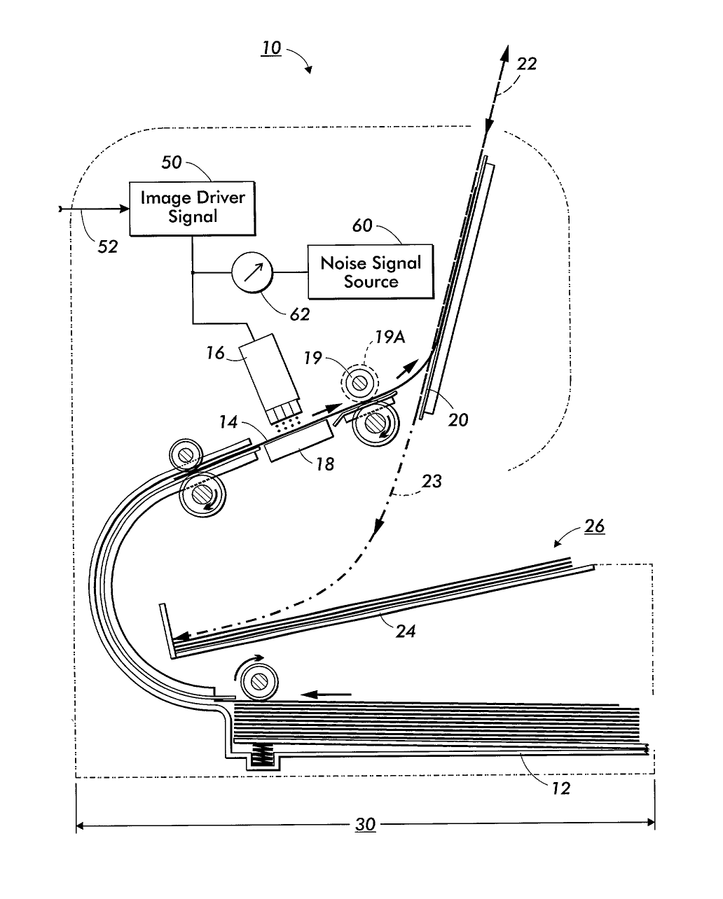

Disclosed herein is a low cost and simple system for reducing certain well known image defects in ink jet type printing systems, especially single pass systems. In particular, there is disclosed a system for doing so by noise or other random induced drop size modulation of the ink jet printing drops from the printing head during printing.

The disclosed system may be applicable to any ink jet printer in which the printhead(s) are capable of modulating the size of the ejected ink drops by its driver or other input signals (for example, but not limited to, known piezoelectric ink jet systems). It has been found that by automatically introducing a comparatively small (low) level of noise signals into single pass printed imaging signals, that the perceptibility of certain systematic printing defects characteristic of single pass printing systems can be minimized.

This superimposed ink jet drop size (and therefor printed spot size) randomness can break up constant systematic errors resulting from an incorrectly ejecting transducer, with the effect of smoothing objectionable process direction streaks in the printed copy. This concept has broad applications for potentially overcoming printhead signatures and eliminating the need for checkerboarding.

Higher productivity ink jet is possible with “full width arrays” of ink jet transducers marking a sheet in a single pass. However, this approach suffers some similar problems as other single pass marking technologies (e.g., LED bars imaging a photoreceptor of a xerographic printer). That is, small variances in the spot size or spot placement due to differences in adjacent or neighboring transducers are magnified in the marking process direction. For example, a transducer making an erroneously small spot size will stably make that small drop size down the entire page in its direction of movement past the imaging bar. Thus, a defect which may be only 42 microns in diameter is magnified to an 8-10″ long line extending in the paper motion direction, and thereby becomes visible and objectionable.

A more conventional small transversely scanning head ink jet printer may have a similar problem to that above for full width array ink jet printers, in that in printing large areas a single clogged nozzle or other defective transducer can cause a highly visible sharp line transverse the printing page in each printing sweep of the printhead. Also, from stitching errors, where one printing head printing sweep does not directly abut the next, as from small paper motion errors.

This concept can be applied to any direct marking technology capable of producing a modulated spot size. Piezoelectric ink jet is one example, but acoustic ink jet printing (AIP) is another example. While the drop size is not normally modulated in AIP, the number of drops that a given pixel receives can be modulated, so a random component of totel spot size can be introduced. Another example is high frequency thermal ink jet, in which many small drops can be used to build up a pixel, much as in AIP. Furthermore, the noise can be injected in a super-pixel element (e.g., a block of 16 pixels). In thermal ink jet printing it may also be possible to vary the drop size by pulse width modulation, or by changes in a pre-pulse.

Since various types, features and details of ink jet printing are well known to those skilled in the art, they need not be described herein. Some recent examples are in U.S. Pat. Nos. 6,116,712; 6,079,814; 6,019,466; 6,012,799; 5,975,681; 5,912,679; and 5,907,331.

Although in a different field, xerographic printing with an LED imaging bar for exposing a photoreceptor, an Eastman Kodak patent, U.S. Pat. No. 5,493,322, issued Feb. 20, 1996 to Yee S. Ng, et al, describes a (much more complex) system for slightly modulating LED emitter's to reduce the perceptibility of somewhat similar systematic errors on the printed copies.

A specific feature of the specific embodiment(s) disclosed herein is to provide an ink jet printing system in which a multiplicity of ink jet drops of a preset normal size are ejected from a plurality of transducer elements of a printhead onto a printing substrate to print images thereon under the control of an imaging input signal, the improvement comprising a random signal generator input to at least some of said transducer elements for randomly slightly varying the size of said ink jet drops relative said preset normal size to reduce the perception of systematic defects in said print images.

Further specific features disclosed in the embodiment(s) herein, individually or in combination, include those wherein said random signal generator input is a noise signal generator operating at a substantially lower level than said imaging input signal.

The disclosed system may be operated and controlled by appropriate operation of conventional control systems. It is well known and preferable to program and execute imaging, printing, paper handling, and other control functions and logic with software instructions for conventional or general purpose microprocessors, as taught by numerous prior patents and commercial products. Such programming or software may of course vary depending on the particular functions, software type, and microprocessor or other computer system utilized, but will be available to, or readily programmable without undue experimentation from, functional descriptions, such as those provided herein, and/or prior knowledge of functions which are conventional, together with general knowledge in the software or computer arts. Alternatively, the disclosed control system or method may be implemented partially or fully in hardware, using standard logic circuits or single chip VLSI designs.

The term “sheet” herein refers to a usually flimsy physical sheet of paper, plastic, or other suitable physical substrate for images, whether precut or web fed.

As to specific components of the subject apparatus or methods, or alternatives therefor, it will be appreciated that, as is normally the case, some such components are known per se in other apparatus or applications which may be additionally or alternatively used herein, including those from art cited herein. All references cited, and their references, are incorporated by reference herein where appropriate for teachings of additional or alternative details, features, and/or technical background. What is well known to those skilled in the art need not be described herein.

Various of the above-mentioned and further features and advantages will be apparent to those skilled in the art from the specific apparatus and its operation or methods described in the examples below, and the claims. Thus, the present invention will be better understood from this description of a specific embodiment, including the drawing figures (which are approximately to scale) wherein:

The Figure is a schematic plan view of an exemplary ink jet printer electronically modified in accordance with one example of the subject system.

Describing now in further detail this exemplary embodiment with reference to the Figure, there is shown one example of an ink jet printer 10, merely by way of illustrating one exemplary application of the present concept.

As indicated above, disclosed herein is a concept for ink jet marking technologies (for example, piezoelectric ink jet) that are capable of modulating the size of the ink drop of introducing a small level of noise in their single pass printed images, in order to minimize the perceptibility of systematic defects characteristic of single pass printing systems. Among other advantages, this superimposed randomness in ejected drop size can break up constant systematic errors resulting from an incorrectly ejecting transducer. The introduced noise component has the effect of smoothing objectionable process direction streaks that would otherwise produce on the printed copy.

Referring to the Figure, this is just one example 10 of many possible ink jet printers, printer configurations and paper path configurations which with the present system may be employed. This particular ink jet printer example also includes other novel features of another inventor which may be the subject of other patent applications, and the present invention is not limited thereto.

In this particular ink jet printer example 10, a sheet 14 of paper, transparency or other suitable ink jet image substrate material is being conventionally fed from a conventional paper tray (or cassette) 12 for imaging by a suitable or conventional ink jet printhead 16. The printhead may be conventionally opposed by a fixed platen 18 as shown, or a conventional cylindrical platen which is rotatable for assisting the paper feeding past the printhead 16.

In this example, an additional feed roller may be provided on the non-imaged side of the sheet 14 downstream of the printhead 16. It may have an opposing idler roller 19 having narrow outside sheet edge engaging roller edges 19A. Whether or not an additional such feed roll system is provided or not, it may be seen that relatively closely downstream from the printhead 16 and platen 18 is a substantially vertically inclined sheet baffle surface 20, preferably at an acute angle to the vertical, and of conventional low friction plastic material. The freshly printed sheet 14 is fed up this vertically inclined baffle 20 as it feeds out of the printhead area, instead of into an output tray. That feeding of the most recently printed sheet 14 up the baffle 20 continues until the trail edge of that sheet has cleared the printhead 16 and any downstream feed roller mechanisms (such as 19, 19A), and any associated guide baffles, such as the upwardly curved baffle shown just downstream of idler roll 19.

At that point, as illustrated by the double-headed arrow 22, the freshly printed sheet 14 is released to slide by gravitational force back down the steeply inclined surface 20, as illustrated by the sheet path 23. The sheet continues to fall on path 23 into an output tray 24, to stack on top of the stack 26 of previously printed sheets in this output tray 24.

It may be seen that with this particular ink jet printing system 10 configuration, there has been provided a relatively much longer sheet output path before sheet stacking. Thus, a much longer ink drying time period is provided before the sheet 14 is stacked on top of the other sheets in the stack 26. Thereby, the likelihood of offsetting of wet ink between subsequent sheets being printed is substantially reduced. Yet, as may be seen, no complex mechanical devices or movements are required in this system 10 for temporarily holding the sheet being outputted up above the stack 26 and then subsequently releasing it. This system 10 is a passive system not requiring any additional moving mechanisms. Furthermore, it may be seen that the critical “footprint” space 30 of the machine 10 is not increased by this system.

Drying time and offsetting of wet ink from one sheet to another in the sheet output is a known problem in ink jet printing, affecting effective printing rates, especially for transparencies. For example, some HP ink jet printers use a mechanical sheet edge guiding rails system, disclosed in U.S. Pat. No. 4,728,963 and equivalents, which holds the sheet above the stack as it exits and then mechanically moves out of the way to drop the sheet onto the stack after the underlying sheet has had time to dry (just before the next sheet must exit). That system requires extra moving (driven) components, and can drop or centrally sag flimsy sheets having insufficient beam strength.

This disclosed system 10 is a low cost non-mechanical system utilizing a redesigned output path and gravity to provide essentially the same advantages of increased ink drying time before stacking of the next-printed sheet, without increasing the printer footprint.

As shown in the Figure, the piezoelectric or other printhead 16 of the exemplary ink jet printer 10 may be conventionally driven by a conventional image driver signal system 50 (including conventional software), from a conventional image source input 52, such as a PC or network connection.

Turning now to the subject system example, it may be seen that in, or electrically connecting with, this printer 10 or its signal input source 52, is a noise signal from a noise signal source 60. That noise signal is superimposed on the image driver signal 50.

It will be appreciated by those skilled in the art that random noise signal generators are well known, even commercially available, and need not be described in any detail herein. The noise level of the noise signal source 60 will, of course, be set so as to not interfere with the imaging, yet provide sufficient variability in the ink jet drop size ejected from the printhead to accomplish the above-described or other image defects compensations. This level of the noise signal source 60 may be either pre-set or variable, as is schematically illustrated in the Figure by the potentiometer or other variable resistor 62 at the output thereof. In practice both the level and frequency of the noise signal may be varied by software or operator control signals thereto in various known ways.

In another variation of this embodiment, each printhead transducer may receive two separate input signals, a conventional signal to eject a drop on demand, and a second signal controlling the drop size to be ejected. This second signal will not simply reflect the nominal drop size desired, but will also have a superposed random incremental signal component that will variably result in a slightly smaller or larger drop size relative the exact drop size requested, as described above.

It will be appreciated from this teaching that various alternatives, modifications, variations or improvements therein may be made by those skilled in the art, which are intended to be encompassed by the following claims.

What is claimed is:

1. In an ink jet printing system in which a multiplicity of ink jet drops of a preset normal size are ejected from a plurality of transducer elements of a printhead onto a printing substrate to print images thereon under the control of an imaging input signal, the improvement comprising a random signal generator input to at least some of said transducer elements for randomly slightly varying the size of said ink jet drops relative said preset normal size to reduce the perception of systematic defects in said print images.

2. The ink jet printing system of claim 1, wherein said random signal generator input is a noise signal generator operating at a substantially lower level than said imaging input signal.
